(19) United States
(12) Patent Application Publication
(10) Pub. No.: US 2020/0279280 A1
(43) Pub. Date: Sep. 3, 2020

(54) Algorithmic generation, qualification, and ranking of potential sales leads for human consumable nondurable goods

(71) Applicants: Ashkan Ziaee, Oakland, CA (US); Felix Skylar Hamilton, Ferndale, CA (US)

(72) Inventors: Ashkan Ziaee, Oakland, CA (US); Felix Skylar Hamilton, Ferndale, CA (US)

(73) Assignee: Liquid Vine Inc., Corte Madera, CA (US)

(21) Appl. No.: 16/805,469

(22) Filed: Feb. 28, 2020

Related U.S. Application Data
(60) Provisional application No. 62/812,733, filed on Mar. 1, 2019.

(51) Int. Cl. G06Q 30/02; G06F 16/2457; G06N 20/00; G06N 5/02

(52) U.S. Cl. CPC G06Q 30/0202; G06Q 30/0201; G06N 5/025; G06N 20/00; G06F 16/24578

(57) ABSTRACT

A software as a service platform employing novel means and methods to do algorithmic generation, qualification, and ranking for potential sales leads targeting a wide range of products that fall under the category of human consumable nondurable goods. By utilizing a wide range of qualitative and quantitative product, sales, and purchaser data as well as manual, hybrid, or algorithmic methods to extract meaningful features from this data and classifiers based on a variety of predictive models such as statistical models, rulesets, clustering models, neural networks, bayesian models, support vector machines, decision trees, graphs, regression models, and many others, the present invention provides a novel framework for the generation, qualification, and ranking of potential sales leads for human consumable nondurable goods.

### BACKGROUND OF THE INVENTION

The present invention is in the technical field of computer software. More particularly, the present invention is in the technical field of computer software as a service. More particularly, the present invention is in the technical field of computer software as a service for the purpose of algorithmic generation, qualification, and ranking of potential sales leads for human consumable nondurable goods based on a wide range of input data sources and systemic feedback signals.

Traditional approaches to lead generation and product recommendation have many significant drawbacks. While some attempts have been made to design algorithmic systems to address sales lead generation and recommendation systems for specific product markets, in most cases non algorithmic approaches are still heavily utilized. Existing algorithmic recommendation systems are generally focused on optimizing consumer purchasing behavior, and are used extensively to select and rank sets of products for individual consumers. Comparable algorithmic recommendation systems designed to generate ranked sets of potential buyers for individual products are not generally utilized. It is clear that existing recommendation and lead generation systems have an inherent directional bias, as they are mostly designed to find n many products to recommend to a single consumer rather than to find n many potential buyers for a single product. On the other hand, algorithmic sales lead generation and ranking methods can be used quite effectively to match individual products to sets of one or more potential buyers, but only for fairly specific product types. The products for which algorithmic methods are used are mostly limited to those with high revenue and profit generating potential such as financial instruments, insurance, real estate, and vehicles, among others. Algorithmic sales lead generation and ranking approaches are not generally utilized for products that do not share these characteristics in whole or in part, and are specifically not often utilized for products which fall under the category of human consumable nondurable goods. Even if algorithmic methods are used for the generation and ranking of sales leads for various human consumable nondurable goods, they do not make use of a sufficiently broad set of input data sources or systemic feedback signals. Such methods usually focus on product data, purchaser data, or sales data but generally not a combination of qualitative and quantitative data on all three. Systemic feedback signals are also often not utilized, as purchasing patterns for durable goods do not have the same recursive predictive utility as they do with respect to nondurable goods, and existing algorithmic sales lead generation and ranking methods have focused for the most part on durable goods as durable goods are much more likely to have high revenue and profit generating potential.

### SUMMARY OF THE INVENTION

The present invention is a software as a service platform employing novel means and methods for the purpose of algorithmic generation, qualification, and ranking of potential sales leads for human consumable nondurable goods based on a wide range of input data sources and systemic feedback signals. By using a comprehensive set of qualitative and quantitative data sets including producer, product, sales, and purchaser information in conjunction with a range of manual, hybrid, and algorithmic based processing, training, analysis, feedback, and ranking methods, the present invention addresses some of the drawbacks associated with existing algorithmic sales lead generation and ranking methods and provides a novel framework for dynamic generation and ranking of potential sales leads for a wide range of human consumable nondurable goods.

### BRIEF DESCRIPTION OF THE DRAWINGS

FIG. 1 provides an overview of the data flow for classifier training in the present invention;

FIG. 2 shows an overview of the data flow for classification in the present invention; and

FIG. 3 provides an overview of the user flow for lead generation in the present invention.

### DETAILED DESCRIPTION OF THE INVENTION

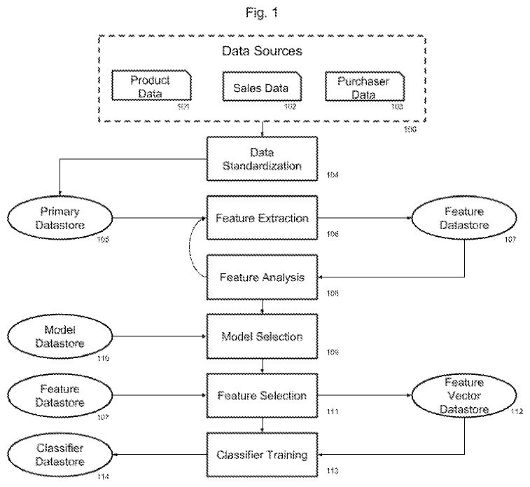

Referring now to the invention in more detail, in FIG. 1 there is shown an overview of the data flow model for classifier training in the present invention. A variety of data sources 100 generally including at least product data 101, sales data 102, and purchaser data 103 is accessed, standardized, and normalized by the data standardization 104 component, and the standardized data thus extracted is then stored by the system in the primary datastore 105. Product data 101 may include but is not limited to data such as tasting notes, wholesale pricing, retail pricing, recipes, flavor pairings, cuisine matching, expert reviews including but not limited to (date, source, details, etc), reviews including but not limited to (date, source, details, etc), ratings including but not limited to (date, source, details, etc), chemical analysis, ingredients, product name, product type, product subtype, producer name, producer location, producer notes, production notes, production date, and sell by date among others. Sales data 102 may include but is not limited to data such as a link to a product identifier, a link to a purchaser identifier, a sales date, number of units sold, unit definition, per unit sale price, and total sales among others. Purchaser data 103 may include but is not limited to data such as location data including but not limited to (address, square footage, etc), demographic data including but not limited to (race, gender, age, income, etc), purchasing history (based on aggregate sales data), product listing including but not limited to (current wine/beer/cocktail menu, food menu, product listings, etc), expert reviews, reviews, ratings, pricing data (based on aggregate sales data), purchaser name, purchaser type, purchaser subtype, purchaser details including but not limited to (license types, health and safety rating, age of business, etc), purchaser inventory history including but not limited to (products in inventory and for how long etc), purchaser event calendar, purchaser preferences, and purchaser systemic metadata including but not limited to (last referenced, last sale, etc) among others. The types of product for which product data 101 is sourced and utilized in the present invention are, in a preferred embodiment, human consumable nondurable goods for which qualitative tasting data can be generated. These include but are not limited to wine, beer, liquor, fresh vegetables, fruits, chocolate, coffee, mushrooms, caviar, cigars, electronic cigarette fluids, cannabis, cannabis extracts, medicinal extracts, condiments, desserts, snacks, chips, sodas, energy drinks, frozen foods, prepared meals, candy, baked goods, meat, fish, protein, supplements, oils, grains, flavored powders, sauces, tea, drinks, kombucha, ciders, herbs, and spices among many others.

In more detail, still referring to the invention of FIG. 1, data sources 100 for product data 101, sales data 102, and purchaser data 103 can include but are not limited to data accessed from local or remote static data files, local databases, remote databases, third party API's, both real and non real time signals, systemic feedback signals, websites, human interaction, or any other sources via programmatic or non programmatic methods.

In more detail, still referring to the invention of FIG. 1, once standardized data is stored in the primary datastore 105 the feature extraction 106 component extracts features from various entities in the primary datastore 105 which are then stored in the feature datastore 107. Features extracted by the feature extraction 106 component may be directly related to entities in the primary datastore 105 or indirectly related to entities in the primary datastore 105. An example of a direct primary relationship between an entity in the primary datastore 105 and an extracted feature stored in the feature datastore 107 could be a production date, while an example of an indirect secondary relationship could be a feature consisting of the top five most frequently occurring words sorted by total word count extracted from an entity in the primary datastore 105 such as an expert review or a menu listing. In general the feature extraction 106 component may employ manual, hybrid, or algorithmic methods to extract features which may include but are not limited to human interactions, rule engines, statistical methods, and machine learning algorithms (i.e. linear regression, logistic regression, cluster analysis, neural networks, etc.) among others.

In yet more detail, still referring to the invention of FIG. 1, once features are extracted 106 and stored in the feature datastore 107 feature analysis 108 is conducted to determine the relative and absolute utility associated with the various primary and secondary features extracted 106 based on a wide variety of potential quantitative and qualitative metrics. These evaluation metrics can include but are not limited to statistical metrics such as mean, median, mode, standard deviation, skew or kurtosis, variance, range, L-statistics, coefficient of variation, covariance, and various correlation measures among many others. In some cases when feature analysis 108 is conducted if one of the analysis metrics falls below or above a desired threshold value for one of the analyzed features, a signal may be sent back to the feature extraction 106 component resulting in the extraction of a different replacement feature or the use of alternative feature extraction methods for the feature in question. In general the feature analysis 108 component may employ manual, hybrid, or algorithmic methods to analyze extracted features which may include but are not limited to human interactions, rule engines, statistical methods, and machine learning algorithms (i.e. linear regression, logistic regression, cluster analysis, neural networks, etc.) among others.

In more detail, still referring to the invention as shown in FIG. 1, the results of feature analysis 108 are used in conjunction with other criteria by the model selection 109 component to select a predictive model from the model datastore 110 to train in the classifier training 113 component. Types of parametric, semi-parametric, and non-parametric predictive models in the model datastore 110 in the preferred embodiment of the current invention may include but are not limited to statistical models, rulesets, clustering models, neural networks, bayesian models, support vector machines, decision trees, graphs, regression models, and many others. Model selection 109 may use a variety of manual, hybrid, or algorithmic methods to select appropriate models from the model datastore 110 based on a broad range of criteria including the results of feature analysis 108. Once a model has been selected 109, feature selection 111 for classifier training 113 can take place. Based on the model selected 109 and the results of feature analysis 108, a set of specific features to use in classifier training 113 is selected using manual, hybrid, or algorithmic methods from the feature datastore 107 and a corresponding set of feature vectors are constructed and stored in the feature vector datastore 112. Classifier training 113 then uses a subset of these feature vectors from the feature vector datastore 112 to train and evaluate a classifier 113 based on the model selected 109. The resulting classifier, classifier metadata, and classifier evaluation results are then stored in the classifier datastore 114 for future use during run time classification 116.

In more detail, still referring to the invention as shown in FIG. 1 to FIG. 3, the functional system components (identified in FIG. 1 to FIG. 3 by solid rectangular borders), namely data standardization 104, feature extraction 106, feature analysis 108, model selection 109, feature selection 111, classifier training 113, classifier selection 115, classification 116, random classification 121, human classification 122, reclassification 123, classification handling 119, feature vector extraction 127, API 124, user interface 125, product entry 126, product selection 128, lead generation 129, lead ranking 130, lead output 131, export functions 132, lead resolution 133, lead conversion analysis 134, and lead data deconstruction 135, in a preferred embodiment of the present invention consist of one or more independent software programs controlled by a single organization or individual running on dedicated compute devices and interacting with each other, their data sources, data stores, and any external users or applications via APIs over LAN, WAN, or wireless network connections.

In more detail, still referring to the invention of FIG. 1 to FIG. 3, in a preferred embodiment of the present invention, all input and output data elements and datastores (identified in FIG. 1 to FIG. 3 by solid ellipsoid borders) associated with each functional system component, namely each primary datastore 105, feature datastore 107, model datastore 110, feature vector datastore 112, classifier datastore 114, and result datastore 120, are stored in independent data stores by type. All data stores are, in a preferred embodiment, controlled by a single organization or individual running on dedicated compute devices each controlling one or more storage devices which provide storage capacity sufficient to redundantly store all data elements associated with each independent data store and interacting with the functional system components, each other, and any external users or applications via APIs over LAN, WAN, or wireless network connections. In alternative embodiments, one, several, or all of the system functional components and data stores together comprising the present invention may be implemented as one or more software programs and data stores controlled by one or more organizations or individuals, and one, several, or all functional components and data stores may be implemented in such a way as to run on a single or several compute and storage devices.

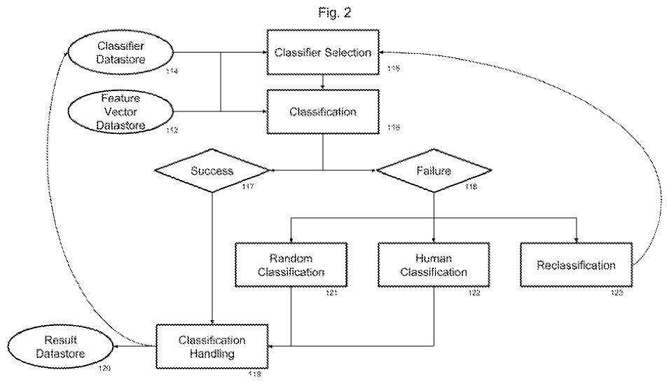

Referring now to the invention in more detail, in FIG. 2 there is shown an overview of the data flow for classification in the present invention. The first step in classification 116 is classifier selection 115 where a classifier is selected from the classifier datastore 114 based on the feature vector obtained from the feature vector datastore 112 to be classified in addition to other selection metrics. The selection metrics utilized in classifier selection 115 can include but are not limited to various direct, indirect, and derived statistical and performance metrics related to the classifier metadata available such as total samples classified, classifier age, true positive, true negative, false positive, and false negative rates as well as various derived measures such as sensitivity, specificity, precision, negative predictive value, accuracy, confusion matrices, logarithmic loss, AUC or area under curve, F1 score or harmonic mean, uncertainty coefficient, mean absolute error, and mean squared error among many others. The classifier selection 115 component can utilize manual, hybrid, and algorithmic methods which may include but are not limited to human interactions, rule engines, statistical methods, and machine learning algorithms (i.e. linear regression, logistic regression, cluster analysis, neural networks, etc.) among others to select a classifier based on the input feature vector and relevant metrics.

In more detail, referring to the invention as shown in FIG. 1 to FIG. 2, once a classifier is selected 115 from the classifier datastore 114 and an input feature vector is acquired from the feature vector datastore 112, the input feature vector is classified utilizing the selected classifier in the classification 116 component. Feature vector classification 116 can result in success 117 or failure 118 which is determined based on a number of potential metrics for each classifier, including but not limited to confidence thresholds and the size and aggregate quality of the result set generated. If classification 116 results in a success 117 the result set generated by classification 116 is sent to classification handling 119 where the members of the result set are entered into the result datastore 120 for the purposes of outcome tracking and future classifier training 113 as well as added to metadata in the classifier datastore 114 for the purposes of classifier evaluation and future classifier selection 115. Classification handling 119 then qualifies and ranks the members of the result dataset before being sending the result dataset on to the end user. Methods utilized by the classification handling 119 component for qualification and ranking of generated result sets can include manual, hybrid, or algorithmic methods such as white and black lists, various ordering signals and rules, preference settings, and confidence values among many others. If classification 116 results in a failure 118 there are several possible outcomes, random classification 121, human classification 122, and reclassification 123. Reclassification 123 is the first preference, in which the sample feature vector is simply reclassified by an alternative choice of classifier in classifier selection 115 assuming there are classifiers available in the classifier datastore 114 which have not previously been used to attempt classification 116 of the sample feature vector. Human classification 122 can also be used when one or all of the classifiers in the classifier datastore 114 have failed to identify the sample feature vector or random classification 121 can be used thereby generating a systemic feedback signal upon the evaluation of result dataset outcomes which can contribute to future classifier training 113. Both human classification 122 and random classification 121 generate a result dataset that is sent to the classification handling 119 component for processing just as the result dataset generated by a classification 116 success 117 is.

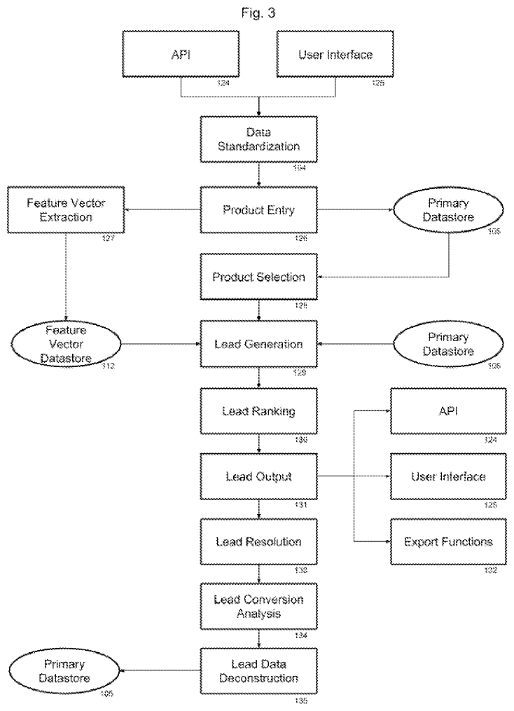

Referring now to the invention in more detail, in FIG. 3 there is shown an overview of the user flow for lead generation of the present invention. The first stage in the lead generation 129 process involves an end user interacting with a user interface 125 or a program interacting via an API 124 (Application Programming Interface) with the system in order to enter a new product 126 or select 128 an existing product from the primary datastore 105 for which to generate a set of potential leads 129. If it is a product new to the system, product data is input via user interface 125 or API 124, standardized 104 and entered into the primary datastore 105 as well as being sent to feature vector extraction 127. The feature vector extracted 127 is stored in the feature vector datastore 112 and sent to lead generation 129 for processing along with the product data from the primary datastore 112. If the product is already stored in the primary datastore 105 the existing product is selected 128 via user interface 125 or API 124 and product data from the primary datastore 105 as well as the associated feature vector from the feature vector datastore 112 are sent to lead generation 129 for processing.

In more detail, still referring to the invention of FIG. 3, in the lead generation 129 component a classifier is selected and classification of the input product feature vector is conducted as previously discussed in the detailed description of classification in FIG. 2 above. The lead dataset generated as a result of running classification on a product feature vector consists of a set of purchasers and classifier generated metadata for each, as well as detailed data for each purchaser which is loaded from the primary datastore 105. Classifier generated metadata for each lead can include match percentage, decision reason, and confidence rating among others. The lead dataset is then sent to the lead ranking 130 component for qualification and ranking. Qualification criteria can vary on a dynamic basis, but frequently includes user defined white lists, black lists, preferences, filters, and many others. Ranking criteria can also be dynamic, but frequently match percentage and confidence rating classifier produced metadata are used. In general, qualification and ranking may employ manual, hybrid, or algorithmic methods which may include but are not limited to human interactions, rule engines, statistical methods, and machine learning algorithms (i.e. linear regression, logistic regression, cluster analysis, neural networks, etc.) among others.

In yet more detail, still referring to the invention of FIG. 3, the qualified and ranked lead dataset generated by the lead ranking 130 component is then sent to the lead output 131 component. Lead output 131 sends the lead dataset directly to end user via user interface 125, to a program via API 124, or to one or more output processing export functions 132. Once the lead dataset makes it to the end user via one or more of these methods, the lead resolution 133 component tracks the outcome associated with each potential sales lead generated. The lead resolution 133 data is used in lead conversion analysis 134 where various success metrics and criteria are generated or evaluated via manual, hybrid, or algorithmic methods. Lead resolution 133 and lead conversion analysis 134 data are then processed by the lead data deconstruction 135 component for storage back in the primary datastore 105 where it will be added to classifier metadata and used in future classifier training 113.

The advantages of the present invention include, without limitation, the ability to standardize, normalize, and extract features from a wide variety of data sources related to human consumable nondurable goods utilizing manual, hybrid, or algorithmic methods. Further, to select, train, and refine classifiers based on those extracted features using a range of predictive models and, most importantly, to generally provide novel means and methods for utilizing those classifiers to generate, qualify, and rank potential sales leads for one or more selected human consumable nondurable goods to the state of the art which are comparable or better than those means and methods currently existing for the generation, qualification, and ranking of potential sales leads for human consumable nondurable goods.

In broad embodiment, the present invention is a software as a service platform which provides the capability to collect, integrate, normalize, and standardize a wide range of qualitative and quantitative data regarding product, sales, and purchaser information via human, hybrid, and algorithmic methods and uses this data to train a wide variety of classifiers based on a number of predictive models in order to use these trained classifiers to generate, qualify, and rank potential sales leads for human consumable nondurable goods.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A sales lead qualification, discovery, and sorting system comprising the following:
a set of one or more persistent data stores of merchant, product, and sales data;
a set of one or more persistent data stores of product data pertaining to human consumable non-durable goods that includes subjective metrics such as tasting profiles;
a set of one or more programmatic engines used to normalize and reconcile merchant, product, and sales data;
a set of one or more feature extraction algorithms or programmatic engines used to extract features from merchant, product, and sales data sets, and store them for future use;
a classification and ranking system which takes one or more products and one or more preference criteria as input and uses a set of one or more algorithms or programmatic engines to generate a ranked list of potential merchant customers for the one or more products.

2. The persistent data store(s) of claim 1, wherein merchant, product, and sales data may be acquired and aggregated from internal or external sources via local or remote static data files, databases, APIs, real or non real time signals, systemic feedback, website access, and human interactions using programmatic or non programmatic methods.

3. The persistent data store(s) of claim 1, wherein the merchant data set includes data such as geographic information, demographic information, market information (for instance place type, reviews, menus, pricing, etc), and second order information extracted and appended by the programmatic engines used to normalize and reconcile merchant, product, and sales data of claim 1.

4. The persistent data store(s) of claim 1, wherein the products data store of subjective metrics includes data that may be human curated or generated via programmatic rule engine(s), independent classification system(s), or third-party data source(s).

5. The persistent data store(s) of claim 1, wherein the sales data set includes information such as the products sold, the merchant, unique product identifiers, unique merchant or purchaser identifier(s), sales date, number of units sold, unit definition, per unit sale price, total sales, or relevant systemic metadata.

6. The set of programmatic normalization and reconciliation engine(s) of claim 1, wherein the engine(s) are used to clean, normalize, associate, deduplicate, and store the merchant, product, and sales data sets which have been aggregated from one or more internal or external sources.

7. The feature extraction algorithm(s) or programmatic engine(s) of claim 1, wherein the features of the product, merchant, and sale data are extracted using methods such as human interactions, rule engines, statistical methods, and machine learning algorithms such as linear regression, logistic regression, cluster analysis, or neural networks.

8. The classification and ranking system(s) of claim 1, wherein the features extracted by the feature extraction algorithm(s) or programmatic engine(s) of claim 1 are used to train a machine learning model that can be used to classify and rank potential merchants.

9. The algorithm(s) or programmatic engine(s) used in classification and ranking of claim 1, wherein features are selected from the feature data store used in claim 1 and then submitted to one to n classification algorithms such as statistical models, rulesets, clustering models, neural networks, bayesian models, support vector machines, decision trees, graphs, regression models, random classification, or human classification.

10. The algorithm(s) or programmatic engine(s) used in classification and ranking of claim 1, wherein methods and models employed for qualifying and ranking output results may include user defined white lists, black lists, preferences, or filters.

11. A sales lead qualification, discovery, and sorting system comprising the following:
a set of one or more persistent data stores of merchant, product, and sales data;
a set of one or more persistent data stores of product data pertaining to human consumable non-durable goods that includes subjective metrics such as tasting profiles;
a set of one or more programmatic engines used to normalize and reconcile merchant, product, and sales data;
a set of one or more feature extraction algorithms or programmatic engines used to extract features from merchant, product, and sales data sets, and store them for future use;
a classification and ranking system which takes one or more merchants and one or more
user preference criteria as input and uses a set of one or more algorithms or programmatic engines to generate a ranked list of potential products for the set of one or
more merchants.

12. The persistent data store(s) of claim 11, wherein the merchant data set includes data such as physical location information, aggregate demographic customer data, purchasing history, product listings, reviews, ratings, aggregate pricing data, inventory history, event calendar, merchant preferences, and relevant systemic metadata.

13. The persistent data store(s) of claim 11, wherein the product data set includes data such as tasting notes, wholesale pricing, retail pricing, recipes, flavor pairings, cuisine matching, reviews, ratings, chemical analysis, ingredient listings, product name, product type, product subtype, producer name, producer location, producer notes, production notes, production date, sell by date, and relevant systemic metadata.

14. The persistent data store(s) of claim 11, wherein the sales data set includes information such as the products sold, the merchant, unique product identifiers, unique merchant or purchaser identifier(s), sales date, number of units sold, unit definition, per unit sale price, total sales, or relevant systemic metadata.

15. The persistent data store(s) of claim 11, wherein merchant, product, and sales data may be acquired and aggregated from internal or external sources via local or remote static data files, databases, APIs, real or non real time signals, systemic feedback, website access, and human interactions using programmatic or non programmatic methods.

16. The set of programmatic normalization and reconciliation engine(s) of claim 11, wherein the engine(s) are used to clean, normalize, associate, and deduplicate the merchant, product, and sales data sets which have been aggregated from one or more internal or external sources.

17. The feature extraction algorithm(s) or programmatic engine(s) of claim 11, wherein methods employed for feature extraction may include human interactions, rule engines, statistical methods, and machine learning algorithms such as linear regression, logistic regression, cluster analysis, or neural networks.

18. The classification and ranking system(s) of claim 11, wherein the features extracted by the feature extraction algorithm(s) or programmatic engine(s) of claim 11 are used to train a machine learning model that can be used to classify and rank potential merchants.

19. The algorithm(s) or programmatic engine(s) used in classification and ranking of claim 11, wherein features are selected from the feature data store used in claim 11 and then submitted to one to n classification algorithms such as statistical models, rulesets, clustering models, neural networks, bayesian models, support vector machines, decision trees, graphs, regression models, random classification, or human classification.

20. The algorithm(s) or programmatic engine(s) used in classification and ranking of claim 11, wherein methods and models employed for qualifying and ranking output results may include user defined white lists, black lists, preferences, or filters.
